(19) United States
(12) Patent Application Publication
(10) Pub. No.: US 2005/0278361 A1
(43) Pub. Date: Dec. 15, 2005

(54) View definition language for network management application development

(76) Inventors: Edward G. Brunell, Chicago, IL (US); Shankar Krishnamoorthy, Scotch Plains, NJ (US); Xiangyang Shen, Naperville, IL (US); Manjula Sridhar, Lisle, IL (US); Dong Zhao, Lisle, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(21) Appl. No.: 10/868,239

(22) Filed: Jun. 15, 2004

(51) Int. Cl. G06F 7/00

(52) U.S. Cl. 707/100

(57) ABSTRACT

Methods of defining views of a distributed system or network to facilitate development of an application program with view management services to manage the distributed system or network are provided. In one embodiment, the method includes: a) defining managed objects in a managed object definition language and storing the definition in managed object definition language files, b) parsing the managed object definition language files to ensure conformity with the managed object definition language and creating an intermediate representation of the distributed system, c) defining views of the managed objects of the distributed system in a view definition language and storing the definition in view definition language files, d) parsing the view definition language files to ensure conformity with the view definition language and creating an intermediate representation of the views, and e) processing the intermediate representation of the distributed system and the views to form programming language classes associated with the view management services.

### CROSS-REFERENCE TO RELATED APPLICATIONS

This application is related to Zhao et al., Attorney Docket No. LUTZ 2 00268 and Lucent Case Name/No. Brunell 1-1-1-1-1, entitled “Run-Time Tool for Network Management Application,” filed Jun. 15, 2004, commonly assigned to Lucent Technologies, Inc. and incorporated by reference herein.

This application is related to Sridner et al., Attorney Docket No. LUTZ 2 00289 and Lucent Case Name/No. Brunell 2-2-2-2-2, entitled “Resource Definition Language for Network Management Application Development,” filed Jun. 15, 2004, commonly assigned to Lucent Technologies, Inc. and incorporated by reference herein.

This application is related to Brunell et al., Attorney Docket No. LUTZ 2 00323 and Lucent Case Name/No. Brunell 4-1-4-4-4-4, entitled “Distribution Adaptor for Network Management Application Development,” filed Jun. 15, 2004, commonly assigned to Lucent Technologies, Inc. and incorporated by reference herein.

This application is related to Zhao et al., Attorney Docket No. LUTZ 2 00325 and Lucent Case Name/No. Brunell 5-2-5-5-5, entitled “Event Management Framework for Network Management Application Development,” filed Jun. 15, 2004, commonly assigned to Lucent Technologies, Inc. and incorporated by reference herein.

This application is related to Sridner et al., Attorney Docket No. LUTZ 2 00326 and Lucent Case Name/No. Brunell 6-1-6-5-6-6, entitled “Managed Object Framework for Network Management Application Development,” filed Jun. 15, 2004, commonly assigned to Lucent Technologies, Inc. and incorporated by reference herein.

This application is related to Shen et al., Attorney Docket No. LUTZ 2 00327 and Lucent Case Name/No. Brunell 7-7-6-7-7, entitled “Data Management and Persistence Frameworks for Network Management Application Development,” filed Jun. 15, 2004, commonly assigned to Lucent Technologies, Inc. and incorporated by reference herein.

This application is related to Sridner et al., Attorney Docket No. LUTZ 2 00328 and Lucent Case Name/No. Brunell 8-2-8-1-8-8, entitled “SNMP Agent Code Generation and SNMP Agent Framework for Network Management Application Development,” filed Jun. 15, 2004, commonly assigned to Lucent Technologies, Inc. and incorporated by reference herein.

### BACKGROUND OF THE INVENTION

The invention generally relates to development of a network management application and, more particularly, to a view definition language and associated commands, parsers, and code generators for network management application development.

While the invention is particularly directed to the art of network management application development, and will be thus described with specific reference thereto, it will be appreciated that the invention may have usefulness in other fields and applications.

By way of background, Guidelines for Definition of Managed Objects (GDMO) and Structure for Management Information (SMI) are existing standards for defining objects in a network. Managed objects that are defined can be accessed via a network management protocol, such as the existing Simple Network Management Protocol (SNMP). Various standards, recommendations, and guidelines associated with GDMO, SMI, and SNMP have been published. GDMO is specified in ISO/IEC Standard 10165/x.722. Version 1 of SMI (SMIv1) is specified in Network Working Group (NWG) Standard 16 and includes Request for Comments (RFCs) 1155 and 1212. Version 2 of SMI (SMIv2) is specified in NWG Standard 58 and includes RFCs 2578 through 2580. The latest version of SNMP (SNMPv3) is specified in NWG Standard 62 and includes RFCs 3411 through 3418.

ISO/IEC Standard 10165/x.722, GDMO, identifies: a) relationships between relevant open systems interconnection (OSI) management Recommendations/International Standards and the definition of managed object classes, and how those Recommendations/International Standards should be used by managed object class definitions; b) appropriate methods to be adopted for the definition of managed object classes and their attributes, notifications, actions and behavior, including: 1) a summary of aspects that shall be addressed in the definition; 2) the notational tools that are recommended to be used in the definition; 3) consistency guidelines that the definition may follow; c) relationship of managed object class definitions to management protocol, and what protocol-related definitions are required; and d) recommended documentation structure for managed object class definitions. X.722 is applicable to the development of any Recommendation/International Standard which defines a) management information which is to be transferred or manipulated by means of OSI management protocol and b) the managed objects to which that information relates.

RFC 1155, Structure and Identification of Management Information for TCP/IP-based Internets, describes the common structures and identification scheme for the definition of management information used in managing TCP/IP-based internets. Included are descriptions of an object information model for network management along with a set of generic types used to describe management information. Formal descriptions of the structure are given using Abstract Syntax Notation One (ASN.1).

RFC 1212, Concise Management Information Base (MIB) Definitions, describes a straight-forward approach toward producing concise, yet descriptive, MIB modules. It is intended that all future MIB modules be written in this format. The Internet-standard SMI employs a two-level approach towards object definition. An MIB definition consists of two parts: a textual part, in which objects are placed into groups, and an MIB module, in which objects are described solely in terms of the ASN.1 macro OBJECT-TYPE, which is defined by the SMI.

Management information is viewed as a collection of managed objects, residing in a virtual information store, termed the MIB. Collections of related objects are defined in MIB modules. These modules are written using an adapted subset of OSI's ASN.1. RFC 2578, SMI Version 2 (SMIv2), defines that adapted subset and assigns a set of associated administrative values.

The SMI defined in RFC 2578 is divided into three parts: module definitions, object definitions, and, notification definitions. Module definitions are used when describing information modules. An ASN. 1 macro, MODULE-IDENTITY, is used to concisely convey the semantics of an information module. Object definitions are used when describing managed objects. An ASN.1 macro, OBJECT-TYPE, is used to concisely convey the syntax and semantics of a managed object. Notification definitions are used when describing unsolicited transmissions of management information. An ASN. 1 macro, NOTIFICATION-TYPE, is used to concisely convey the syntax and semantics of a notification.

RFC 2579, Textual Conventions for SMIv2, defines an initial set of textual conventions available to all MIB modules. Management information is viewed as a collection of managed objects, residing in a virtual information store, termed the MIB. Collections of related objects are defined in MIB modules. These modules are written using an adapted subset of OSI's ASN.1, termed the SMI defined in RFC 2578. When designing an MIB module, it is often useful to define new types similar to those defined in the SMI. In comparison to a type defined in the SMI, each of these new types has a different name, a similar syntax, but a more precise semantics. These newly defined types are termed textual conventions, and are used for the convenience of humans reading the MIB module. Objects defined using a textual convention are always encoded by means of the rules that define their primitive type. However, textual conventions often have special semantics associated with them. As such, an ASN. 1 macro, TEXTUAL-CONVENTION, is used to concisely convey the syntax and semantics of a textual convention.

RFC 2580, Conformance Statements for SMIv2, defines the notation used to define the acceptable lower-bounds of implementation, along with the actual level of implementation achieved, for management information associated with the managed objects.

Network elements need a way to define managed resources and access/manage those resources in a consistent and transparent way. GDMO does not provide a straight forward approach to defining resources. SMI does not provide for an object-oriented design of network management applications. Neither standard provides sufficient complexity of hierarchy or sufficient complexity of control for management of today's complex networks, particular today's telecommunication networks.

The present invention contemplates a view definition language for network management application development that resolves the above-referenced difficulties and others.

### SUMMARY OF THE INVENTION

A method of defining a view of a distributed system to facilitate development of an application program with view management services to manage the distributed system is provided. In one aspect, the method includes: a) defining one or more managed objects associated with the distributed system in an object-oriented managed object definition language and storing the definition of the one or more managed objects in one or more managed object definition language files, wherein the definition of the one or more managed objects is based on an existing design and hierarchical structure of the distributed system, wherein parent-child relationships between the one or more managed objects are identified in the one or more managed object definition language files using the object-oriented managed object definition language to define the one or more managed objects in relation to the hierarchical structure of the distributed system, b) parsing the one or more managed object definition language files to ensure conformity with the object-oriented managed object definition language and creating an intermediate representation of the distributed system from the one or more conforming managed object definition language files, c) defining one or more views of the one or more managed objects of the distributed system in a view definition language and storing the definition of the one or more views in one or more view definition language files, wherein the view definition language is based at least in part on the managed object definition language, d) parsing the one or more view definition language files to ensure conformity with the view definition language and creating an intermediate representation of the one or more views of the distributed system from the one or more conforming view definition language files, and e) processing the intermediate representation of the distributed system and the one or more views of the distributed system to form one or more programming language classes associated with the view management services.

A method of defining a view of a network to facilitate development of an application program with view management services to manage the network. In one aspect, the method includes: a) defining one or more managed objects associated with the network in an object-oriented managed object definition language and storing the definition of the one or more managed objects in one or more managed object definition language files, wherein the definition of the one or more managed objects is based on an existing design and hierarchical structure of the network, wherein parent-child relationships between the one or more managed objects are identified in the one or more managed object definition language files using the object-oriented managed object definition language to define the one or more managed objects in relation to the hierarchical structure of the network, b) parsing the one or more managed object definition language files to ensure conformity with the object-oriented managed object definition language and creating an intermediate representation of the network from the one or more conforming managed object definition language files, wherein the intermediate representation of the network created in the parsing step includes object meta-data, c) defining one or more views of the one or more managed objects of the network in a view definition language and storing the definition of the one or more views in one or more view definition language files, wherein the view definition language is based at least in part on the managed object definition language, d) parsing the one or more view definition language files to ensure conformity with the view definition language and creating an intermediate representation of the one or more views of the network from the one or more conforming view definition language files, wherein the intermediate representation of the one or more views of the network includes view meta-data, and e) processing the object meta-data and the view meta-data to form one or more programming language classes associated with the view management services, wherein the one or more programming language classes formed include at least one of a managed object view class, an abstract view class, a callback class, a view definitions class, and a view factories class.

In another aspect of the method of defining a view of a network to facilitate development of an application program with view management services to manage the network, the method includes: a) defining one or more managed objects associated with the network in an object-oriented managed object definition language and storing the definition of the one or more managed objects in one or more managed object definition language files, wherein the definition of the one or more managed objects is based on an existing design and hierarchical structure of the network, wherein parent-child relationships between the one or more managed objects are identified in the one or more managed object definition language files using the object-oriented managed object definition language to define the one or more managed objects in relation to the hierarchical structure of the network, b) parsing the one or more managed object definition language files to ensure conformity with the object-oriented managed object definition language and creating an intermediate representation of the network from the one or more conforming managed object definition language files, wherein the intermediate representation of the network includes object meta-data, c) defining one or more views of the one or more managed objects of the network in a view definition language and storing the definition of the one or more views in one or more view definition language files, wherein the view definition language is based at least in part on the managed object definition language, d) parsing the one or more view definition language files to ensure conformity with the view definition language and creating an intermediate representation of the one or more views of the network from the one or more conforming view definition language files, wherein the intermediate representation of the one or more views of the network includes view meta-data, and e) processing the object meta-data and the view meta-data to form one or more programming language classes associated with the view management services, wherein the one or more programming language classes include a managed object view class, an abstract view class, a callback class, a view definitions class, and a view factories class, wherein the abstract view class includes a cache view class and a database view class, wherein the cache view class includes a CORBA view class.

Benefits and advantages of the invention will become apparent to those of ordinary skill in the art upon reading and understanding the description of the invention provided herein.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of an embodiment of a reusable asset center (RAC) development environment for development of network management applications.

FIG. 2 is a block diagram of an embodiment of a run-time network management environment with network management applications developed by the RAC development environment.

FIG. 3 is a block diagram of an embodiment of a resource definition language file(s) block of the RAC development environment.

FIG. 4 is a block diagram of an embodiment of a parser(s) block of the RAC development environment.

FIG. 5 is a block diagram of an embodiment of an options block of the RAC development environment.

FIG. 6 is a block diagram of an embodiment of a code generator(s) block of the RAC development environment.

FIG. 7 is a block diagram of an embodiment of a RAC management framework block of the RAC development environment.

FIG. 8 is a block diagram of an embodiment of a run-time tool(s) block of the RAC development environment.

FIG. 9 is a block diagram of an embodiment of a RAC development environment for generating view definition language (VDL) code.

FIG. 10 is a block diagram of various classes of VDL code generated by the RAC development environment and associated with an exemplary managed object (XX).

### DETAILED DESCRIPTION OF THE PREFERRED EMBODIMENTS

Referring now to the drawings wherein the showings are for purposes of illustrating the preferred embodiments of the invention only and not for purposes of limiting same.

In general, a reusable asset center (RAC) development environment for network management application development is provided. RAC, as used herein, generically refers to a reusable set of frameworks for network management application development. The set of frameworks is referred to as the RAC management framework. Network, as used herein, generically refers to a system having a set of resources arranged in a distributed architecture. For example, the RAC development environment may be used to develop network management applications for a TCP/IP-based network or any other type of communication network. For example, the RAC development environment may be used to develop network management applications for landline and/or wireless telecommunication networks. Likewise, the RAC development environment may be used to develop management applications for any type of system having a distributed architecture. Defined as such, the RAC framework is inherently reusable in other networks (i.e., systems). Moreover, major portions of code used to build management applications in the RAC development environment are inherently reusable.

The RAC development environment includes a Managed Object Definition Language (MODL) to specify managed objects in a network or system design and management information associated with the managed objects. The syntax for MODL is object-oriented and the semantics are similar to GDMO. This provides a simplified language for defining data models and acts as a single point translation mechanism to support interacting with different schema types. In essence, MODL provides a protocol-independent mechanism for accessing management information for managed objects within the network design. MODL can be used to define data models describing the managed resources of the network design in terms of managed resources having managed objects, define data types (attributes) representing various resources and objects, and define relationships among the managed resources and objects.

MODL allows network management applications to specify the resources to be managed in a given network design. The RAC development environment also includes MODL code generation from MODL files defining the managed objects and information. This provides automatically generated code to access these resources. Network management application developers can choose to make these resources persistent or transient. Developers can choose among various options to customize the code generation to suit the needs of the operators/maintainers (i.e., providers) of the network. MODL is object-oriented and allows applications to capture complex resources in a systematic way.

The RAC management framework provides an operation, administration, and maintenance (OAM) management framework catering to common OAM needs of the network and its managed resources and objects. The services offered by the RAC management framework range from standard system management functions to generic functions, such as event management, SNMP proxy interface, persistency services, and view management. These services are offered in a protocol-independent and operating system-independent manner.

Most of the common OAM needs of network elements are described in the ITU-T specifications X-730 through X-739 and are known as system management functions. The process leading to development of a RAC management framework provides for systematic and consistent reuse of code. In addition to requirements prescribed by applicable standards, the RAC management framework also provides, for example, functionalities such as persistence, view management and SNMP interface capabilities.

The following requirements of ITU-T X.730 (ISO/IEC 10164-1: 1993(E)) associated with Object Management Function (OMF) services are fully supported in the RAC management framework: 1) creation and deletion of managed objects; 2) performing actions upon managed objects; 3) attribute changing; 4) attribute reading; and 5) event reporting. The RAC management framework also provides, for example, ITU-T X.731-like state management functionality through effective use of callbacks and event reporting.

The RAC management framework provides, for example, a minimal subset of attributes for representing relations as described in ITU-T X.732 (ISO/IEC 10164-3). Certain attributes in the RAC management framework provide, for example, ways to define and create parent and child relationships between managed resources. This enables developers to specify hierarchical structures in the data model representing the network design.

The RAC management framework includes a standalone event management framework to implement event-handling services as described by. ITU-T X.734 (ISO/IEC 10164-5). Regarding event-handling services, the RAC management framework, for example, permits: 1) definition of a flexible event report control service that allows systems to select which event reports are to be sent to a particular managing system, 2) specification of destinations (e.g. the identities of managing systems) to which event reports are to be sent, and 3) specification of a mechanism to control the forwarding of event reports, for example, by suspending and resuming the forwarding.

In addition to standard services, the RAC management framework provides additional capabilities associated with the functionality of various potential network elements. The RAC management framework also provides facilities to maintain data integrity in terms of default values and range checks and persistency of managed resources. For example, managed objects can be made persistent and all the OMF services are supported on these persistent managed objects. The managed objects can be manipulated from the back-end using standard Java database connectivity (JDBC) interfaces and synchronization is maintained so as to retain data integrity. This enables developers to manipulate data from multiple interfaces.

The RAC management framework provides a concept of views and view management services. Many network management applications, especially client applications, do not want to access or store the information about all the objects in the data model. The concept of views in the RAC management framework allows developers to create network management applications with access to a subset of the data model. Network management application developers can specify a view using a View Definition Language (VDL) that is included in the RAC development environment. View management services can be used to manage a cross-section of managed objects and associated resources in a single unit called a View. Most of the OMF services are also provided through the views.

The RAC management framework allows transparent distribution of the network management application. This decouples the network management application from changes in platforms and middleware environments. The network management application can be deployed in agent clients and agent servers servicing operation and maintenance centers (OMCs) (i.e., managers). The interface to the OMC can be Common Object Request Broker Architecture (CORBA), SNMP, JDBC, or another standard communication protocol for network management. For example, by simple inheritance, the agent server interface to the OMC can be extended to support other network management protocols, such as common management information protocol (CMIP), extensible markup language (XML), etc.

One of the key advantages for developers is that the RAC development environment automates development of portions of code with respect to the overall network management application. The RAC development environment generates the code based on the data model defined in MODL. The objects in the model get translated into subclasses in MODL code and access to the objects is generated using a build process in the RAC development environment. If the data model changes, corresponding MODL files can be revised and corresponding MODL code can be re-generated. Thus, streamlining change management of the network management application. The revised network management application is provided in a consistent and controlled manner through the object-oriented programming characteristics of MODL and the RAC management framework.

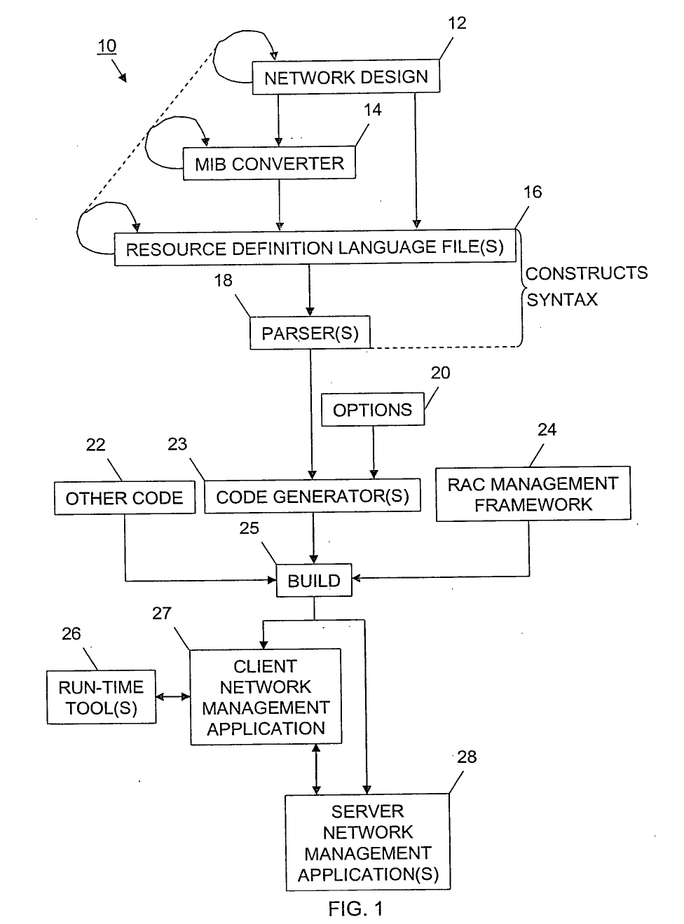

With reference to FIG. 1, a RAC development environment 10 includes a network design 12, an MIB converter 14, a resource definition language file(s) block 16, a parser(s) block 18, an options block 20, an other code block 22, a code generator(s) block 23, a RAC management framework block 24, a build process 25, a run-time tool(s) block 26, a client network management application 27, and a server network management application(s) 28. The RAC development environment 10 also includes computer hardware for storing and/or operating the various software development processes shown in FIG. 1. The computer hardware used in conjunction with the RAC development environment 10 may range from a network with multiple platforms to a stand-alone computer platform. The various processes for software development described herein may operate on any suitable arrangement of various types of computer equipment with various types of operating systems and various types of communication protocols. Thus, it is to be understood that the software development processes described herein do not require any specialized or unique computer architecture for the RAC development environment 10. The RAC development environment 10 represents an exemplary development cycle used by developers when preparing network management applications. Typically, developers begin with a design or data model for a network or system. This is depicted by the network design 12 and may include any design documentation describing the network and its resources or elements that is useful to the developers (i.e., data model). The network design 12 may include an existing MIB for one or more network resources.

If the network design 12 includes one or more MIBs, the MIB converter 14 converts the information in the MIBs to resource definition language file(s) 16. The developers use the network design 12 as source data for representing the remaining network resources and objects to be managed in the resource definition language file(s) block 16. The developers may also use the network design 12 to integrate the file(s) created by the MIB converter 14 with the other file(s) in the resource definition language file(s) block 18. Thus, the resource definition language file(s) block 16 includes one or more files defining the resources and objects within constructs and in appropriate syntax for one or more resource definition languages associated with the RAC development environment 10. Additional files may be included in the resource definition language file(s) block 18 defining one or more views of the resources and/or objects.

Files from the resource definition language file(s) block 18 are provided to an appropriate parser in the parser(s) block 18 to check for construct and syntax compliance and to build a parse tree. The parse tree is provided to the code generator(s) block 23. The options block 20 specifies certain options related to code generation by the code generator(s) block 23. The code generation options are customized by the developers based on the network design, parse tree, developer preferences, and/or network management application customer/user preferences.

The code generator(s) block 23 generates code for each managed resource and object defined in the resource definition language file(s) 16. The generated code provides various hooks and callbacks, which can be used by the developers to customize the flow of operations and behavior of the network management applications. The generated code primarily includes extensions of RAC management framework classes and eases the burden of coding and maintaining repeated functionality. The RAC management framework block 24 includes code organized in a group of subordinate frameworks. The RAC management framework 24 is implemented as a set of interrelated patterns (i.e., frameworks) that provide common functionality which can be selectively associated with the managed resources/objects and included in the generated code. The other code block 22 includes, for example, user-specific code and main methods which perform the initialization to get the final network management application.

The generated code from the code generator(s) block 23 is compiled and linked with code from the other code block 22 and the RAC management framework block 24 in the build process 25 to create a client network management application 27 and one or more server network management applications 28. At any stage in the application development, developers can add, delete or modify the managed resources/objects in the resource definition language files, re-generate the resource definition language code with new and/or revised managed resources/objects, and re-build the network management applications.

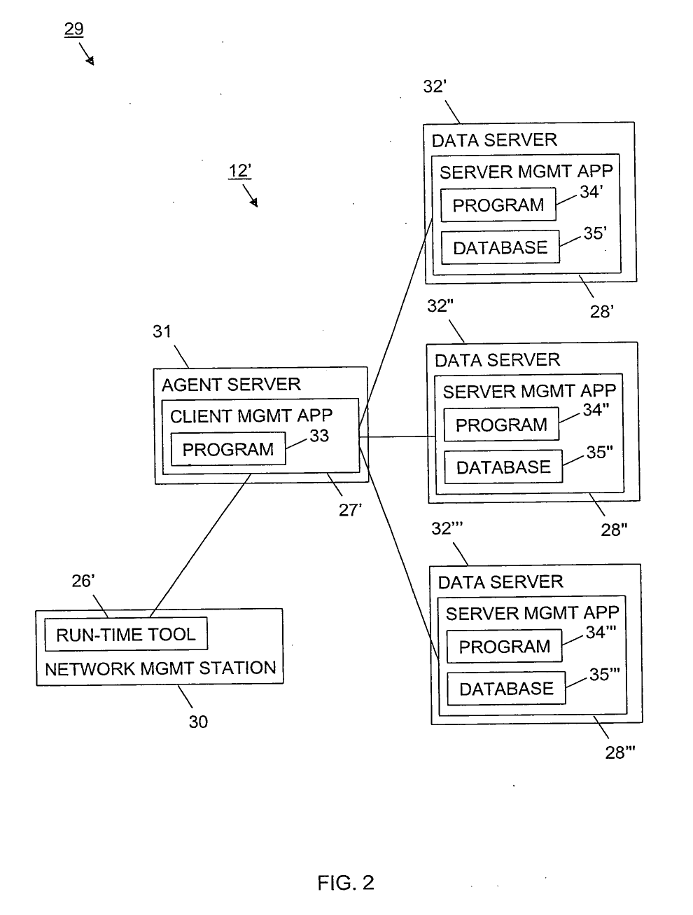

With reference to FIG. 2, an embodiment of a run-time network management environment 29 includes a network design 12′ to be managed in communication with a network management station 30. The network design includes an agent server 31 in communication with a first data server 32′, a second data server 32″, and a third data server 32′″. The network management station 30 includes an embodiment of the run-time tool 26′. The agent server 31 includes an embodiment of the client network management application 27′. The data servers 32′, 32′″, 32′″ each include a corresponding embodiment of the server network management application 28′, 28″, 28′″. The client network management application 27′includes an application program 33. Each server network management application 28′, 28″, 28′″ includes a corresponding application program 34′, 34″, 34′″ and management database 35′, 35″, 35′″.

Each of the data servers 32′, 32″, 32′″ includes one or more objects to be managed. For example, if any two network resources 32 are the same and the objects to be managed for both resources are also the same, the corresponding server network management application 28 may be the same on both resources. Otherwise, the application programs 34 and management databases 35 in the client network management applications are different based on the type of resource and/or type of objects to be managed.

The run-time tool 26′ controls and monitors the data servers 32′, 32″, 32′″ through communications with the client network management application 27′. The client network management application 27′ passes communications from the run-time tool 26′ to the appropriate server network management application 34. The client network management application 27′ also passes communications from the server network management applications 34′, 34″, 34′″ to the run-time tool 26′.

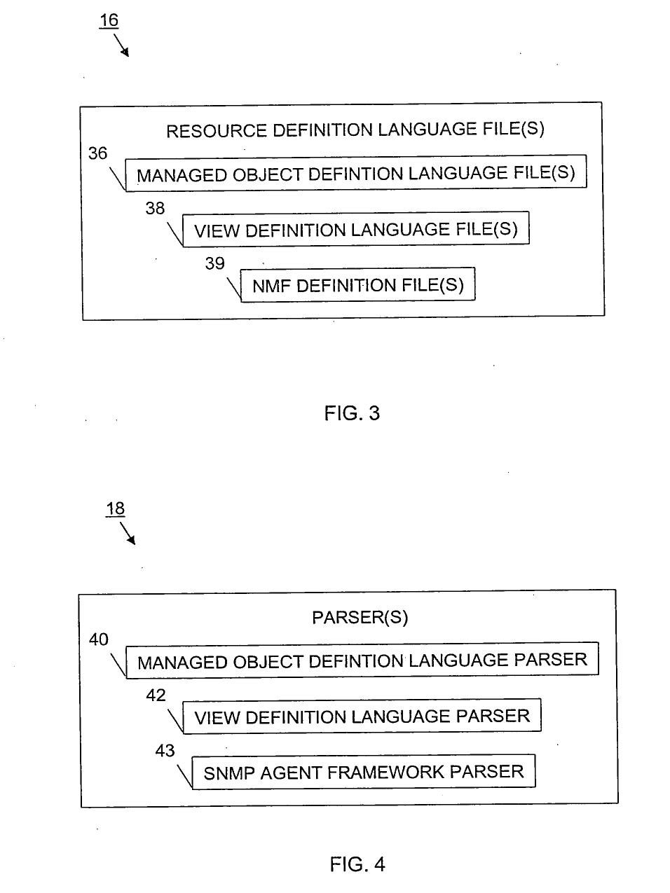

With reference to FIG. 3, an embodiment of the resource definition language file(s) block 16 includes managed object definition language (MODL) file(s) 36, view definition language (VDL) file(s) 38, and network management forum (NMF) file(s) 39. The VDL file(s) 38 are optional. MODL is a language used to organize the managed resources. MODL allows for definition of managed resources as managed object classes. The MODL file(s) 36 include constructs to organize the data model of the network design into managed object classes. This facilitates readability and provides a mechanism for abstracting the managed resources in the network design. VDL is a specification language based on MODL that describes managed object views. Each VDL file 38 (i.e., managed object view) is a collection of managed attributes that are scattered across various managed objects. The VDL file(s) 38 are entities that are essentially wrappers for corresponding managed objects included in the respective managed object views. The NMF file(s) 39 acts as an input for generating the classes required to access the managed objects and their attributes. The NMF file(s) 39 supply mapping information between MIB tables and managed object classes.

With reference to FIG. 4, an embodiment of the parser(s) block 18 includes an MODL parser 40, a VDL parser 42, and an SNMP agent framework (SAF) parser 43. The VDL parser 42 is optional. The MODL parser 40 receives the MODL file(s) 36 and builds an intermediate representation of the file contents that includes a parse tree and object meta-data. The parse tree and object meta-data is provided to the code generator(s) 23 for generation of MODL and database management code. The object meta-data is also provided to the VDL parser 42. The VDL parser 42 receives the VDL file(s) 38 and the object meta-data and builds view meta-data. The object meta-data and view meta-data are provided to the code generator(s) 23 for generation of VDL code. The SAF parser 43 receives MODL files created by the MIB converter and the NMF files and creates an output that is provided to the code generator(s) 23 for generation of SAF code.

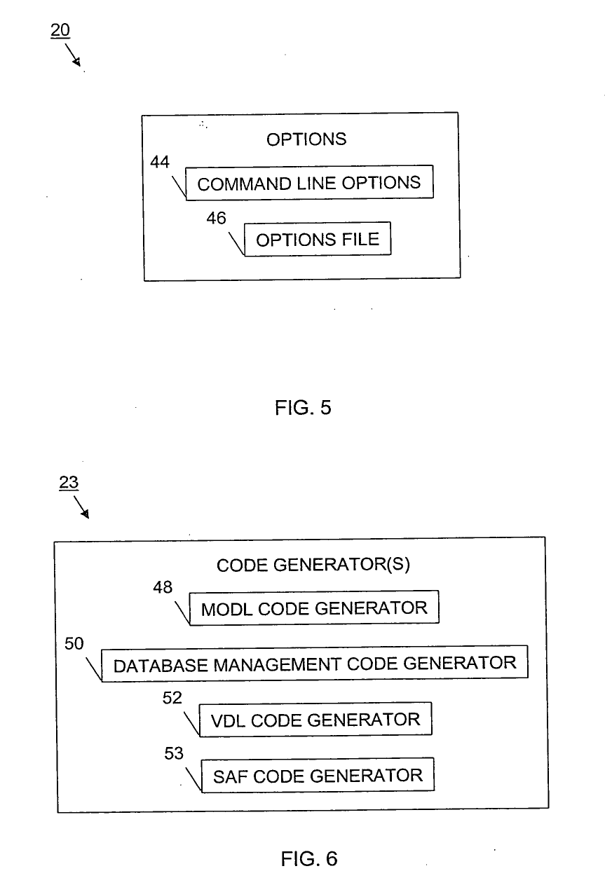

With reference to FIG. 5, an embodiment of the options block 20 includes command line options 44 and an options file 46. The options file 46 is optional. The command line options 44 include arguments and parameters to commands to initiate code generation. Various combinations of arguments and parameters are optional and permit developers to customize code generation to the current stage of application development and their current needs. The options file 46 is a sequence of commands in a file that similarly permit developers to customize code generation. The options file 46, for example, can specify reuse of code that was generated previously so that current code generation may be limited to areas that have changed.

With reference to FIG. 6, an embodiment of the code generator(s) block 23 includes an MODL code generator 48, a database management code generator 50, a VDL code generator 52, and an SAF code generator 53. The MODL code generator 48 receives the parse tree from the MODL parser 40 and instructions from the option(s) block 20 for generation of MODL code. The MODL code generator 48 generates code for instantiating and accessing the managed resources and objects in the network design from the MODL file(s) 36. The database management code generator 50 receives object meta-data from the MODL parser 40 and instructions from the option(s) block 20 for generation of database management code. The database management code generator 50 generates database schema for transient and/or persistent managed objects and trigger definitions for database updates from the MODL file(s) 36. The VDL code generator 52 receives view meta-data from the VDL parser 42 and instructions from the option(s) block 20 for generation of VDL code. The VDL code generator 52 generates code for defining managed object views from the MODL file(s) 36 and VDL file(s) 38. The SAF code generator 53 generates code for providing an SNMP interface to managed object resources.

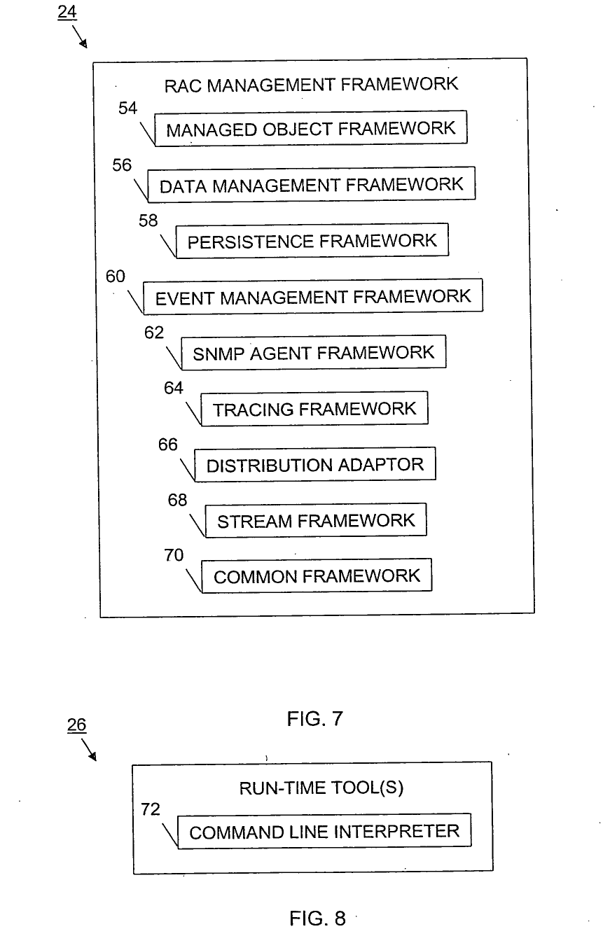

With reference to FIG. 7, an embodiment of the RAC management framework block 24 includes a managed object framework (MOF) 54, a data management framework (DMF) 56, a persistence framework (PF) 58, an event management framework (EMF) 60, an SNMP agent framework (SAF) 62, a tracing framework 64, a distribution adaptor (DA) 66, a stream framework 68, and a common framework 70. MOF 54 includes a set of classes that work in close cooperation to provide the management functionality of the network management applications. The MOF 54 is the core framework and provides object representations and interfaces for network management applications.

DMF 56 is used to make certain managed objects persistent and makes these persistent managed objects accessible to network management stations (NMSs). The DMF 56 also maintains consistency of the persistent data and permits various servers within the network design to share the data, for example, in real-time. PF 58 provides a portable persistent database interface to network management applications. This permits MODL and other coding for the applications to be developed transparent of any underlying database implementation.

EMF 60 includes a centralized event management server that performs event management routing and broadcasting. The EMF 60 unifies various system event generations and handling schemes into one uniform event processing model. SAF 62 provides network management applications with a gateway between MOF and SNMP protocols. SAF 62 acts as a proxy for SNMP protocol. SAF 62 also provides an interface definition language (IDL) interface through which other system elements can communicate using CORBA.

The tracing framework 64 provides network management applications with an option to emit tracing information that can be saved to a log file for subsequent problem analysis. The tracing framework 64 provides developers and users with multiple tracing levels. DA 66 is an adaptation layer framework for transparent distributed programming. DA 66 provides a pattern for utilizing client and server object proxies to allow code for distributed applications to be written without having to explicitly deal with distribution issues.

The stream framework 68 supports the encoding of objects into a stream and the complementary reconstruction of objects from the stream. The stream framework 68 permits objects to be passed by value from the client to the server through various communication mechanisms. The common framework 70 includes a set of utility classes that are used across the RAC management framework 24. The common framework 70 reduces redundancy across the RAC management framework 24, thereby reducing code for network management applications.

With reference to FIG. 8, an embodiment of the run-time tool(s) block 26 includes a command line interpreter 72. The command line interpreter 72 is a utility for monitoring and controlling managed objects associated with a network management application. The command line interpreter 72 includes interactive and batch modes of operation.

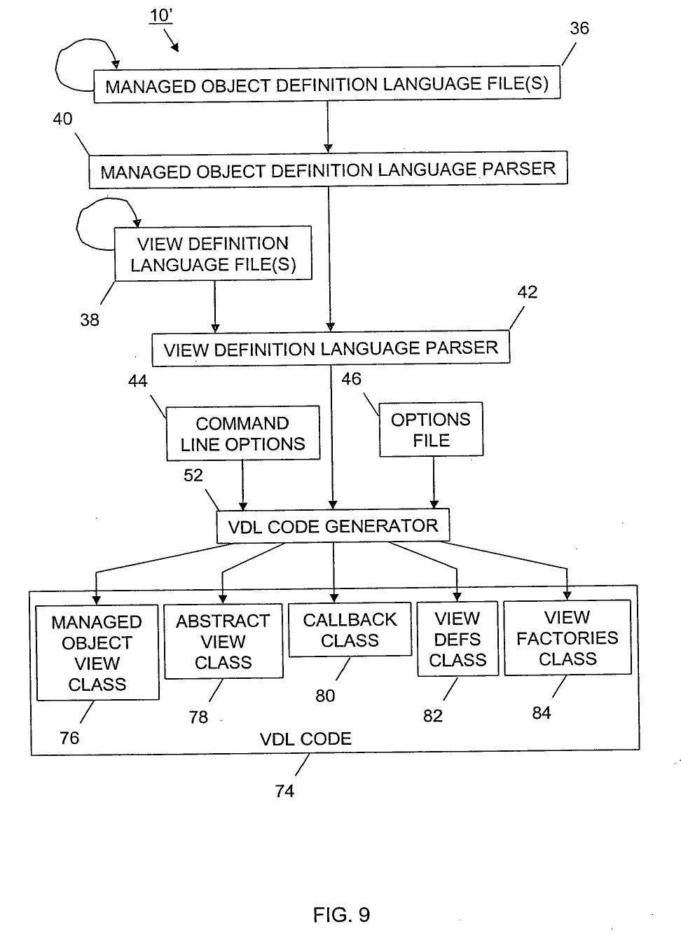

With reference to FIG. 9, an embodiment of a RAC development environment 10′ for generating VDL code includes the MODL file(s) 36, VDL file(s) 38, MODL parser 40, VDL parser 42, command line options 44, options file 46, VDL code generator 52, and VDL code 74. The VDL code 74 includes a managed object view class 76, an abstract view class 78, a callback class 80, a view definitions (view defs) class 82, and a view factories class 84. As described above in reference to FIGS. 1 and 3, the MODL file(s) 36 and VDL file(s) 38 are prepared and provided to the MODL parser 40 and VDL parser 42, respectively. The MODL parser 40 parses the file(s) and provides object meta-data to the VDL parser 42 as described above in reference to FIGS. 1 and 4. Similarly, the VDL parser 42 receives the VDL file(s) 38 and the object meta-data and builds view meta-data. The object meta-data and view meta-data are provided to the VDL code generator 52 for generation of the VDL code 74. If implemented, the options file 46 is prepared and provided to the VDL code generator 52 as described above in reference to FIGS. 1 and 5. A command to initiate the VDL code generator 48 is entered with selected command line options 44 and executed as described above in reference to FIGS. 1 and 5. The VDL code generator 52 generates VDL code 74 for defining managed object views from the MODL file(s) 36 and VDL file(s) 38 as described above in reference to FIGS. 1 and 6.

VDL is a specification language that describes a ManagedObjectView class associated with the Data Management Framework (DMF). The ManagedObjectView class is a collection of managed attributes that are scattered across various managed objects. ManagedObjectViews are similar to a traditional relational Database Views. A traditional relational Database View is a virtual table that performs a “join” on a set of other tables when the view is accessed. However, a ManageObjectView is an entity of its own and can exist even if the ManagedObject(s) it is associated with does not exist. This is because the ManagedObjectView is essentially a wrapper over managed objects.

Views are considered to be facade to the application data. A ManagedObjectView can be a single interface through which the application can retrieve the data it wants without having to find out how the data is organized. The view can also have the index. The view index is used to filter out the data from the database. For example, the database can contain multiple instances of a Bts object. A view that is encapsulating the Bts object can be made to refer to only one instance of Bts which is specified as view index. Thus, only specified Bts can be accessed from that view instance. Other instances of the same view class can access other Bts objects.

VDL includes a number of reserved keywords. For example, the reserved keywords may include: view, index, class, and readwrite. Moreover, VDL is based on a resource definition language, such as MODL. Thus, the resource definition language (e.g., MODL) is a prerequisite for the definition of VDL keywords. The table below provides the general meaning for each VDL keyword:

| KEYWORD | MEANING |
|---|---|
| view | Defines the name of the view. |
| index | Defines the indexes of the view. The view index is used |
| | to filter out the data from the database. For example, the |
| | database can contain multiple instances of an object. |
| | A view that is encapsulating that object, can be |
| | made to refer to only one instance, which is specified as |
| | a view index. Other instances of the same view class |
| | can access other objects. |
| class | Used to define which attributes from the given managed |
| | object class are to be contained in the view. |
| readwrite | specifies whether individual set methods will |
| | be generated |

An example of extreme backus normal form (EBNF) grammar for defining a view is shown below:

<ViewDeclaration>::= “view” <Identifier> “{“
(<IndexDeclaration>)? (<ViewEntryDeclaration>)+ “}”
<IndexDeclaration>::= “index” “{“
(<IndexVariableDeclaration>)+ “}”
<IndexVariableDeclaration>::= <Identifier> ( “.”
<Identifier>)* (“;”)?
<ViewEntryDeclaration>::= (“readwrite”)? “class”
<FullyQualifiedName>
( “*” |
(<Identifier> (“,”)? )+ ) “;”
<FullyQualifiedName> ::= <Identifier> ( “.”
<Identifier>)*
<Identifier>::= <Letter> (<Letter>|<Digit>)*
<Letter>::= [“_”,”a”-”z”,”A”-“Z”]
<Digit>::= [“0”-“9”]

The statement “view” <Identifier> defines the name of the view. The statement <IndexVariableDeclaration> is used to define the index variables used for the view. These declarations are the index variables for each managed object the view is monitoring. The indexes are provided when the view is opened. (Note: a const index does not need to be provided, as the view already has that information.) The index variables may be a subset of the managed object's index variable. This is when the managed object has a range defined for one or more of its index variables. Under these circumstances, those indexes may be left out and the view will monitor all possible managed object's in the range. For example, a managed object, such as MoC, is defined with an index as follows:

```
index {
    const Integer ViewExample = 1;
    Integer index1;
    Integer index2 = 0 valid { 0 - 10 }
}
```

The view Index can then be defined as follows:

index {
ViewExample.index1
}

An instance of this view is accessible when index1 is provided. When index1 is provided the view will monitor all MoCs whose index1 is equal to the index1 provided. This works with more than one managed object with ranges if the other non-range index variables for each managed object are the same.

The statement <ViewEntryDeclaration> is where the actual managed object that will be monitored is defined. The first part of this statement is the <FullyQualifiedName>. This is the full name of the managed object. If the managed object is in a module, the module name is pre-pended to the managed object class name. The second part of the statement is where the list of attributes associated with the managed object that will be monitored are defined. If all attributes are desired to be monitored, an asterisk “*” can be used to denote all attributes. For example, if one wants to create a view on managed objects MoA, MoB, and MoC using all the attributes from MoA and a subset of attributes from MoB and MoC, the MODL file for defining the managed objects includes the following:

```
module ViewExample {
    class MoA {
        index {
            const Integer ViewExample = 1;
            Integer IndexMoA;
        }
        Integer a1;
        String a2;
    };
    class MoB {
        index {
            const Integer ViewExample = 1;
            Integer IndexMoB;
        }
        Integer b1;
        String b2;
    };
    class MoC {
        index {
            const Integer ViewExample = 1;
            Integer IndexMoB;
            Integer IndexMoC = 0 valid { 0 = 10 };
        }
        Integer c1;
        String c2;
    };
}
```

The corresponding VDL file, for example, includes the following:

```
view ViewExample //Define the name of the view
{
    index {
        ViewExample.IndexMoA ; //Index declaration of MoA
        ViewExample.IndexMoB ; //Index declaration of MoB
    }
    class ViewExample.MoA *;//list of attributes from MoA
to watch
    class ViewExample.MoB b1;//list of attributes from MoB
to watch
    class ViewExample.MoC c2; //list of attributes from
MoC to watch
}
```

The options file 46 is the customizing input file provided to the VDL code generator 48 along with VDL file(s) and the parsed MODL file(s). The file provides customization of the generated VDL code and includes a sequence of commands separated by a semicolon. Each command has a unique name and a list of arguments. The option file 46 is typically named with a opt extension, but other naming schemes can be used. The file is typically passed to the VDL code generator with -o option. Other suitable arrangements to specify the options file may also be implemented.

The options file 46 permits and encourages reuse of code that was previously generated in the current code generation process. This also permits a set of reusable managed object definitions to be written separately in corresponding MODL and VDL file. The code generated or modified (if necessary) can be made into a reusable library. The management application can make use of the reusable library without generating anything for the reusable MODL and VDL files/managed objects.

The various commands available to developers for customizing VDL code generation using the options file 46 include: include-module, exclude-module, collection-mo-list, default-mo-list, root-dm-gen-flag, root-dm-class-name, generate-make-file-flag, make-file-name, compact-mo-gen-flag, row-status-flag, enforce-enum-flag, generate-root-classes-flag, mo-impl-name, and mo-impl-gen-flag.

The “include-module” command specifies a module name to be included. All the modules for which code is to be generated are included using an include-module command. If a given module is not included, sub-modules associated with that module are also not included for the code generation even if they are specified in the options file. The syntax for the include-module command is as shown below:

include-module <name of the module>;

The “exclude-module” command causes the code generator to ignore all the classes defined in that particular module. The syntax for the exclude-module command is as shown below:

exclude-module <name of the module>;

The “persistent-mo-list” and “collection-mo-list” commands are used to specify that the corresponding resource is to be made persistent. Persistent-mo followed by a list of managed object names tells the code generators to generate all the managed objects listed as persistent managed objects. For each class defined as persistent, a subclass of ManagedObject, PersObjectHandle, and ModlCollectionAdaptor are generated.

When multiple managed objects are used with the persistent-mo-list or the collection-mo-list, managed objects higher in the hierarchy (i.e., parents) are usually mentioned first, followed by the related children. The persistent managed object values are stored in the database. If a server reboots, the managed objects can be loaded and the system state is retained. The syntax for the persistent-mo-list and collection-mo-list commands are shown below:

persistent-mo-list <name of mol>, <name of mo2>..;
collection-mo-list <name of mol>, <name of mo2>..;

The “default-mo-list” command is used to specify the managed objects that are not persistent (i.e., transient managed objects). These are dynamic managed objects and reside in main memory. The values for transient managed objects are lost if the server crashes or reboots. The syntax for the default-mo-list is shown below:

default-mo-list <name of mol>, <name of mo2>...;

The “root-dm-gen-flag” command tells the code generator to generate the RootDm class when set to true. This provides a convenient way of loading the managed objects from the database to the servers. By default, the flag is true. The syntax for the root-dm-gen-flag command is shown below:

root-dm-gen-flag <true/false>;

The “root-dm-class-name” command is used in conjunction with the root-dm-gen-flag. By default, the generated class name is RootDm. The root-dm-class-name command specifies another class name for the root dm class. The root dm class is used to load all persistent managed objects from the database in the data server. The syntax for the root-dm-class-name command is shown below:

root-dm-class-name <class name>;

The “generate-make-file-flag” command tells the code generator to generate a makefile when set to true. By default, the flag is true. Developers can turn off generation of the makefile by setting the flag to false. The syntax for the generate-make-file-flag command is shown below:

generate-make-file-flag <true/false>;

The “make-file-name” command is used in conjunction with the generate-make-file-flag. By default, for example, the generated makefile name is “ModlGen.mk”. The make-file-name command specifies another name for the generated makefile. The syntax for the make-file-name command is shown below:

make-file-name <name of the file>;

The “compact-mo-gen-flag” command is deprecated if the code generator generates compact managed objects by default. Otherwise, the compact-mo-gen-flag command is used to specify whether or not the code generator is to generate compact managed objects.

The “row-status-flag” command indicates whether the system is being managed by SNMP. If set to true, the code generator generates an additional Integer attribute for each persistent managed object associated with the amount of persistent data to be stored. The additional attribute is used to decide whether a given managed object can be created or deleted. By default, the flag is set to false. The syntax for the row-status-flag command is shown below:

row-status-flag <true/false>;

The “enforce-enum-flag” command is used in conjunction with enum definitions in the MODL and VDL files. When set to true, the flag tells the code generator to generate a function called isEnumValid inside the Enum namespace. The generated method will also be called inside the generated classes when attempt to create or modify an enum attribute occur. By default, the flag is set to false. The syntax for the enforce-enum-flag command is shown below:

enforce-enum-flag <true/false>;

The “generate-root-classes-flag” command tells the code generator to generate the classes corresponding to root module, such as “AttrDefns,” “MoDefns,” “EnumDefns,” “EnumAttrFactory,” as well as the root ddm, pmo adaptor class when set to true. The flag is true by default. The syntax for the generate-root-classes-flag command is shown below:

generate-root-classes-flag <true/false>;

The “mo-impl-name” command specifies the mo-impl name to be used for the given managed object. This may be useful when the implementation already exists. All that is needed is to generate the managed object to make use of the existing implementation. The syntax for the mo-impl-name command is shown below:

mo-impl-name <module.mo> <name of the Impl>;

The “mo-impl-gen-flag” specifies whether an implements class needs to be generated for a particular managed object. Implements classes are generated when a particular managed object had an action defined or when a developer specifies the mo-impl-name command for that managed object. When the flag is set to false, it is expected that a corresponding mo-impl-name command is also provided to specify the name of the implements class. The syntax for the mo-impl-gen-flag is provided below:

mo-impl-gen-flag <true/false>;

The command line options 44 are associated with a command to initiate the VDL code generation processes. The command line options are arguments that may be specified in the command to customize the subsequent code generation. The syntax for the command and associated command line options is provided below:

vdlGen -l viewnames|all -i viewnames|all -v vdlFile -m
odlFile -o opt file -g gen dir

The “l viewnames|all” command line option specifies the list of views that will access the database directly. The “i viewnames|all” command line option specifies the list of all views that will access the database remotely using CORBA for communication. Note, all views in the “i” list are also in the “l ” list. The “v vdlFile command line option specifies the VDL file(s). The “m odlFile” command line option specifies the file name that contains the MODL specification for the given network. element. The −m command line option is, for example, a mandatory argument. Multiple MODL files can be specified using multiple −m options in the command line. The “o opt file” command line option specifies the code generation option file that is used by the code generator during code generation. The “g gen dir” command line option specifies the directory where the output file is generated.

The VDL code generator 74 is designed to generate managed object view class 76 implementations on managed objects. The RAC development environment 10′ provides the MODL file(s) 36 that are parsed by the MODL parser 40. VDL parser 42 reads the various managed object meta-data through the MODL parser 40 and the VDL file(s) 38 to build the view meta-data. The VDL code generator 52 reads the view meta-data as well as managed-object-meta-data to generate the various view classes (i.e., managed object view class 76, abstract view class 78, callback class 80, view definitions class 82, and view factories class 84).

The managed object view class 76 is provided by the RAC DMF framework. This class provides the base or general API for accessing views. Other view classes should derive from the managed object view class 76. The abstract view class 78 provides the specialized API for accessing the view. As with the managed object view class, As denoted by its name, this class is an abstract like the managed object view class. For example, for a given view XX, the name of the abstract view class 78 is XXView.

The callback class 80 may be used by an application to inform the application when a managed object that is being monitored is deleted, created, or changed. If an application wishes to receive this information via callbacks, the methods in this class are implemented. For example, for a given view XX, the name of the callback class is XXViewCallback. The view defs class 82 provides views of the meta-data. This class is used by the managed object view class 76. An application process that intends to use a view XX, calls the method create XXViewDef( ). The view factories class 84 implements a factory pattern for the creation of view instances. The factory is registered with a call to CORBA or the database, depending on which type of view the application process intends to use.

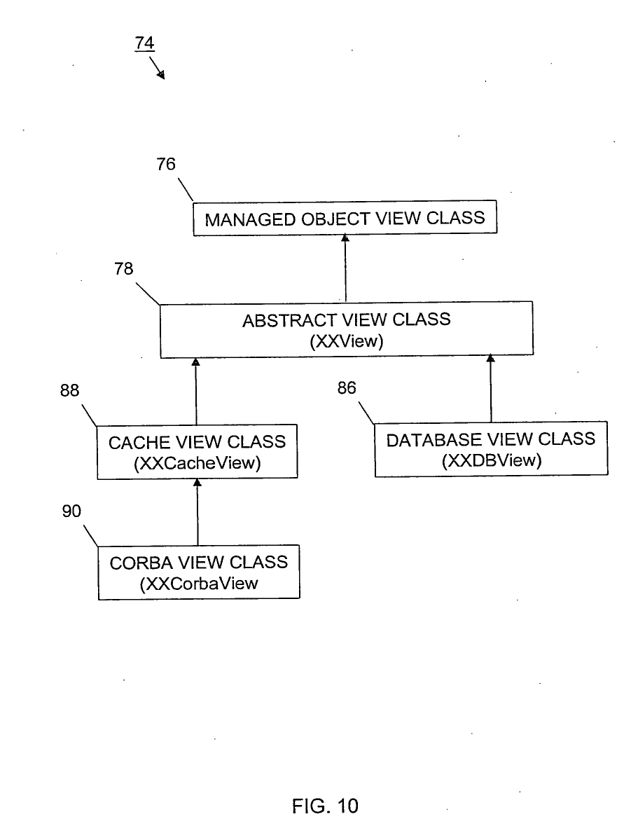

With reference to FIG. 10, a block diagram of various classes of VDL code 74 associated with an exemplary managed object (XX) includes the managed object view class 76, an XXView from the abstract view class 78, an XXDBView from a database view class 86, an XXCacheView from a cache view class 88, and an XXCorbaView from a CORBA view class 90. The database view class 86 is a concrete class derived from the abstract view class 78. This class is used to directly read managed objects from the database using managed object handles. The database view class 86 can wrap managed objects that are in the database. This class works with persistent objects even if the objects are not loaded into main memory. As shown, for a given view XX, the name of the database view class 86 is XXDBView. The cache view class 88 is an abstract class derived from the abstract view class 78. This class caches the view data into client local address space. Access to view is read directly from the local cache. A method in the cache view class 88, such as syncView, is provided to automatically update the cached view data. Since this class is abstract; it does not have a mechanism to fetch the data initially. As shown, for a given view XX, the name of the cache view class 88 is XXCacheView. The CORBA view class 90 is a sub-class of the cache view class 88. This class provides implementations for a method(updateHandles) that is responsible for retrieving the managed object attributes that are associated with the view. As shown, for a given view XX, the name of the CORBA view class 90 is XXCorbaView.

With respect to view programming, the managed object view server local keeps a reference of each call to openView and when all references to a view are removed (e.g., via subsequent calls to closeView) the view is deleted. Note, for every call to openView, a call to closeView is needed in order for the view to be deleted. When using CorbaViews, a corresponding DBView is created on the data server. When the CorbaView is initialized, the DBView is closed and subsequently deleted to save resources on the data server.

There are two versions of the openView/closeView APIs. The first version is a generalized form located in the RAC management framework 24 and the second version is a specialized form generated by the VDL code generator 52 (FIG. 9).

An example of the generalized form of openView is shown below:

```
ManagedObjectView * MoViewServerLocal::openView(
    const std::string viewClassName,
    const DistinguishedName viewInstanceID,
    int flags=0)
```

The generalized form of openView increments the view's reference counts and returns a pointer to the view from the global list. If no view exists in the global list, a new view is created using the registered factory and added to the global list. viewClassName is the name of the view created. viewInstanceId is the view instanceId created. Flags are used to change the way the view is initialized. For example, the lateInitFlag is a flag to indicate if the view should delay its initialization. This form of openView returns a pointer to the view or it returns a zero if it is unable to create a new view and RubyError will be set to indicate the failure.

An example of the specialized form of openView is shown below:

XXView* XXView::openView( [ViewIndexVariables,] bool
lateInitFlag=false);

In the specialized for of openView, the viewIndexVariables are the index variables defined in the VDL file(s) and used to create the viewInstance Id. The specialized form of openView calls the generalized form of openView using the newly constructed viewInstanceId and the static method getViewName_ to get the viewClassName. For example, ManagedObjectView :: openView (XXView :: getViewName_( ), viewInstanceId,lateInitFlag).

An example of the generalized form of closeView is shown below:

int MoViewServerLocal::closeView( ManagedObjectView*&
aView);

The generalized for of closeView decrements the view's reference count. When there are no more references to the view, aView is deleted and set to zero. aView is a reference to the pointer to close the managed object view instance. The generalized form of closeView returns a zero on success and a non zero on error.

An example of the specialized form of closeView is shown below:

int XXView::closeView( XXView*& aView);

The specialized form of closeView internally calls the generalized form, the only difference is in the type of aView.

The following paragraphs provide exemplary code for using a view. In this example, there are two types of processes; one is a managed object or data server which is identified as DataServer.1 and the other is a client server which is identified as HWServer.1 through HWServer.10. The MODL code includes two classes of managed objects and uses one view of the two managed object classes. The client servers use the CacheView and CORBA as the communication median. Each client server is only interested in one cell object and all radio objects with that cell.

First, the MODL code is defined as follows:

| #filename DemoSystem.odl | |
|---|---|
| module DemoSystem { | |
| class Cell { | |
| index { | |
| const Integer DemoSystem = 1; | |
| Integer | CellId; |
| } | |
| Integer | attr1; |
| Integer | attr2; |
| DisplayString(4) | attr3; |
| }; | |
| class Radio { | |
| index { | |
| const Integer DemoSystem = 1; | |
| Integer | CellId; |
| Integer | RadioId = 1 valid {1-10} |
| }; | |
| Integer | attr4; |
| Integer | attr5; |
| }; | |
| }; | |

Next, the corresponding VDL code is defined as follows:

#filename DemoSystem.vdl
view CellSite {
index {
DemoSystem.CellId;
};
class DemoSystem.Cell attr2,attr2;
class DemoSystem.Radio *;
};

The corresponding options file is defined as follows:

#file DemoSystem.opt
collection-mo-list DemoSystem.Cell,
DemoSystem.Cell.Radio;

Next, the code generation process is initiated using the commands and command line options shown below:

ModlGen -m DemoSystem.odl -o DemoSystem.opt -g ./modlGen
DbGen -m DemoSystem.odl -o DemoSystem.opt -g ./dbGen
ViewGen -m DemoSystem.odl -o DemoSystem.opt -v
DemoSystem.vdl -l all -i all -n all -g ./viewGen

In order to enable the managed object server to process remote request for the view, the following instructions are included in appropriate C++ code:

```
DataServerMain.C
...
#include “mof/AttributeServerImpl.h”
#include “mof/MofNotifierImpl.h”
#include “dmf/PersAttributeServerLocal.h”
#include “dmf/MoViewServerImpl.h”
//include generated headers
#include “AttrDefns.h”
#include “MoDefns.h”
#include “ViewDefs.h”
#include “CellSiteDBView.h”
...
int main(...)
{
    ServerId serverNameId(“DataServer”,1);
    ServerId::thisServerId(serverNameId);
    //Register your Modefns and AttrDefns
    AttrDefns::registerAttributeFactories( );
    MoDefns::createManagedObjectDefs( );
    //initialize and open your database
    if(PersInitializer::init( ) !=0 )
    {
        cout << “Failed to init database” << endl;
        cout << RubyError::stringify( ) << endl;
        exit (−1);
    }
    //Register this process to use the DBView
    CellSiteDBView::useThisView( );
    ViewDefs::create( );
    RUBY_TRY {
        CORBA::ORB_var orb = CORBA::ORB_init(argc, argv);
      //Initialize our CORBA Objects
      POA_AttributeServer_tie<AttributeServerImpl>*
asiServant =
          RUBY_COBRA_NEW
POA_AttributeServer_tie<AttributeServerImpl>(
            new AttributeServerImpl(
                new PersAttributeServerLocal(1)));
      POA_MofNotifier_tie<MofNotifierImpl>*
notifierServant =
          RUBY_CORBA_NEW
POA_MofNotifier_tie<MofNotifierImpl>(
                new
MofNotifierImpl(MofNotifierLocal::instance( ));
      POA_ViewServer_tie<MoViewServerImpl>* viewservant =
          RUBY_CORBA_NEW
POA_ViewServer_tie<MoViewServerImpl>(
                new MoViewServerImpl );
        //register your servants with your POA(s)
      //register your objectrefs so they can be retrieved
by your client
      //enter your CORBA loop
      orb->run( );
    }
    RUBY_CATCH(CORBA::SystemException, se) {
      RUBY_PRINT_SYSTEM_EXCEPTION(se);
    }
    RUBY_CATCHANY{
      cerr << “main: Unrecognized exception in main loop”
<< endl;
    }
}
```

In order to set up the client servers to use CorbaView for the view, the following instructions are included in appropriate C++ code:

```
HWServerMain.C
...
#include “mof/AttributeServerImpl.h”
#include “mof/MofNotifierImpl.h”
#include “dmf/PersAttributeServerLocal.h”
#include “dmf/MoViewServerImpl.h”
//include generated headers
#include “AttrDefns.h”
#include “ViewDefs.h”
#include “CellSiteCorbaView.h”
...
//include application headers
//Make sure you have implemented your own
//ServerMap and ViewServerMap
#include “YourServerMap.h”
#include “YourViewServerMap.h”
int main(int argc,char** argv)
{
    //Assume our instanceId is the first argument
    int instanceId = atoi(argv[1]);
    ServerId serverNameId(“HWServer”,instanceId );
    ServerId::thisServerId(serverNameId);
    //Set your ServerMaps
    ServerMap::instance(new YourServerMap );
    ViewServerMap::instance(new YourServerMap );
    //Register your AttrDefns
    AttrDefns::registerAttributeFactories();
    //Register this process to use the CorbaView
    CellSiteCorbaView::useThisView();
    //Register your ViewDefinitions
    ViewDefs::create();
    //This class will update your views from
MOFnotification.
    ViewNotifier::instance( new LocalViewNotifier() );
    //Create the ViewModifierAdaptors to receive the
MOFNotification
    //and pass it to the ViewNotifier
    ViewModifierMoAdaptor viewMoAdaptor1(
      DemoSystemAttrDefns::Cell::getFullClassName());
    ViewModifierMoAdaptor viewMoAdaptor2(
      DemoSystemAttrDefns::Radio::getFullClassName());
    RUBY_TRY {
      CORBA::ORB_var orb = CORBA::ORB_init(argc, argv);
      //Initialize our CORBA Objects
      //This is needed to receive the MOFNotifications
      POA_AttributeServer_tie<AttributeServerImpl>*
asiServant =
        RUBY_CORBA_NEW
POA_AttributeServer_tie<AttributeServerImpl>(
            new AttributeServerImpl(
                new AttributeServerLocal));
      MofNotifierInterface* notifier =
        ProxyFinder<MofNotifierInterface>::GetProxy(
                “DataServer”, “DataServer”, 0 );
      //Register to receive MOF notifications only for the
Cell
      //were watching and all objects underneath that Cell
      //if watching more than 1 cell change registration
      //to a registerForClass instead of
registerForObjectTree
      DistinguishedName cellDn;
      DemoSystemCellMO::getDefaultDn(cellDn);
      cellDn.setValue(1,instanceId);
      notifier->registerForObjectTree(cellDn, serverNameId,
        MofNotifierInterface::Push,
        MofNotifierInterface::MofAll);
      //register your servants with your POA(s)
      //register your objectrefs so they can be retrieved
by your client
      //enter your CORBA loop
      orb->run();
    }
    RUBY_CATCH(CORBA::SystemException, se) {
      RUBY_PRINT_SYSTEM_EXCEPTION(se);
    }
    RUBY_CATCHANY{
      cerr << “main: Unrecognized exception in main loop”
<< endl;
    }
}
```

At this point, the exemplary view is set up in the application program. The exemplary code provided below is associated with actually making use of the view. In the HWServerProcess, the following should be performed after initialization is complete. For purposes of the example, assume that the ServerId for the process is HWServer.1 which means the view instance created will monitor the cell object with a DistinguishedName of DemoSystem.1.CellId.1 and will monitor all radio objects with a DistinguishedName in the range DemoSystem.1.CellId.1.RadioId.1 through DemoSystem.1.CellId.1.RadioId.10. Next, a reference to the view is retrieved. Recall that the first time some a reference to a view is retrieved is when the view is actually created.

```
MoViewServerInterface* vsi =
MoViewServerLocal::instance( );
DistinguishedName cellDn;
DemoSystemCellMO::getDefaultDn(cellDn);
cellDn.setValue(1,ServerId::thisServerId( )-
>getInstanceId( ));
DistinguishedName radioDn1;
DemoSystemRadioMO::getDefaultDn(radioDn1);
radioDn1.setValue(1,ServerId::thisServerId( )-
>getInstanceId( ));
radioDn1.setValue(2,1);
...
...
DistinguishedName radioDn10;
DemoSystemRadioMO::getDefaultDn(radioDn10);
radioDn10.setValue(1,ServerId::thisServerId( )-
>getInstanceId( ));
radioDn10.setValue(2,10);
DistinguishedName viewInstanceId;
CellSiteView::getDefaultId( viewInstanceId );
viewInstanceId.copyAttributesFrom(cellDn);
//Note the cellDn is DemosSystem.1.CellId.1 but the
viewinstanceId will be CellId.1. This is because the
DemoSystem in the Cell Class is const so the view can
infer that data.
CellSiteView* myView = (CellSiteView*) vsi->openView(
        “CellSite”,viewInstanceId);
or
CellSiteView* myView = CellSiteView::openView(
        ServerId::thisServerId( )->getInstanceId( ));
//Once you have the reference you can optionally check
the state of the view to ensure that is was able to
contact the database. 2 methods are provided to do this
myView->isError( );
//returns true if an error condition exists
//You can then use getViewStatus to retrieve the error
RacError theError = myView->getViewStatus( );
to read from the view make sure to lock it first
myView->lock( );
//There are many ways to read data from the view. The
ManagedObjectView class provides some generic API's that
can be used for any type of view. Also the generated
AbstractView class defines some more specific APIs based
on the views's definition.
//Here are some generic ways at getting the View's Data
that will work for any type of View.
const ManagedObjectView::MoViewAttributeListMap& viewData
=
        myView->getViewData( );
//This will return a std :: map <DistinguishedName,
AttributeList*> containing all of the view's cache. You
can query this map based on Cell DistinguishedName or
Radio DistinguishedName. If a given DN that this view
instance is watching does not exist in the Map then that
MO does not exists. NOTE you cannot use this to query
MO's outside this view instances range.
ManagedObjectView::MoViewAttributeListMap::cont_iterator
it;
AttributeList* attrList;
it = viewData.find(cellDn);
if(it == viewData.end( ) )
{
    //Cell must not exist
}
attrList = (*itr).second;
//This attrlist will contain all the Attributes of Cell
that were listed in the VDL file. For this case it is
attr2 and attr3
it = viewData.find(radioDn5);
if(it == viewData.end( ) )
{
    //radio5 must not exist
}
attrList = (*itr).second;
//This attrlist will contain all the attribute from radio
because * was specified in the VDL.
Or
attrList = myView->getMoAttributes(cellDn);
//will return NULL if the cell object does not exist.
attrList = myView->getMoAttributes(radioDn2);
//will turn NULL if the radio 2 does not exist.
//Or use the generated APIs which will construct the DN
for you and query the MoViewAttributeListMap.
attrList = myView->getCellAttributeList( );
//returns the attributeList for the Cell Object we are
watching will return NULL if the CELL object does not
exist
attrList = myView->getRadioAttributeList(5);
//returns the attributeList for radio 5 if it exists
//releases the lock on the current view
myView->unlock( );
myView->updateDatabase(radioDn2,anAttrList);
//This will change the underlining ManagedObject
specified by the DN. It will use the NameServer to get
the ServerId of the server that actually is managing the
MO. Then it will make an AttributeServerInterface::set
call on that server. Your cache will get updated
indirectly via a mof notification call. Your view will
get updated indirectly via a MOFNotification call which
may arrive in another thread. WARNING: Your view should
not be locked by the current thread when doing this. If
it is locked then the Server sending the MOF
notifications will have to wait until your view is
unlocked which could cause a deadlock.
myView->syncView( );
//Forces the view cache to re-sync with the database
//Now we are done with the view we can release our
reference to it by calling. NOTE when no more references
exists the view object will be deleted. If it is desired
to keep the view then you should ensure that at least 1
reference to the view is left outstanding.
int ret = vsi->closeView(myView);
or
int ret = CellSiteView::closeView(myView);
```

The above description merely provides a disclosure of particular embodiments of the invention and is not intended for the purposes of limiting the same thereto. As such, the invention is not limited to only the above-described embodiments. Rather, it is recognized that one skilled in the art could conceive alternate embodiments that fall within the scope of the invention.

1. A method of defining a view of a distributed system to facilitate development of an application program with view management services to manage the distributed system, the method including the steps:
a) defining one or more managed objects associated with the distributed system in an object-oriented managed object definition language and storing the definition of the one or more managed objects in one or more managed object definition language files, wherein the definition of the one or more managed objects is based on an existing design and hierarchical structure of the distributed system, wherein parent-child relationships between the one or more managed objects are identified in the one or more managed object definition language files using the object-oriented managed object definition language to define the one or more managed objects in relation to the hierarchical structure of the distributed system;
b) parsing the one or more managed object definition language files to ensure conformity with the object-oriented managed object definition language and creating an intermediate representation of the distributed system from the one or more conforming managed object definition language files;
c) defining one or more views of the one or more managed objects of the distributed system in a view definition language and storing the definition of the one or more views in one or more view definition language files, wherein the view definition language is based at least in part on the managed object definition language;
d) parsing the one or more view definition language files to ensure conformity with the view definition language and creating an intermediate representation of the one or more views of the distributed system from the one or more conforming view definition language files; and
e) processing the intermediate representation of the distributed system and the one or more views of the distributed system to form one or more programming language classes associated with the view management services.

2. The method as set forth in claim 1 wherein the distributed system is a network.

3. The method as set forth in claim 2 wherein the network is a telecommunication network.

4. The method as set forth in claim 1 wherein the programming language classes include at least one of a “managed object view” class, an “abstract view” class, a “callback” class, a “view definitions” class, and a “view factories” class.

5. The method as set forth in claim 1 wherein the programming language classes include an “abstract view” class and at least one of a “cache view” class and a “database view” class.

6. The method as set forth in claim 1 wherein the programming language classes include an “abstract view” class, a “cache view” class, and a “CORBA view” class.

7. The method as set forth in claim 1 wherein the view definition language reserves at least one of a “view” keyword, an “index” keyword, a “class” keyword, and a “readwrite” keyword.

8. The method as set forth in claim 1 wherein the view definition language reserves a “view” keyword, wherein each “view” keyword specifies a name for a corresponding view of one or more managed objects in the distributed system.

9. The method as set forth in claim 1 wherein the view definition language reserves an “index” keyword and the “index” keyword specifies one or more indexes for each view, wherein each index specifies one or more instances of the one or more managed objects in the distributed system that are included in the view.

10. The method as set forth in claim 1 wherein the view definition language reserves a “class” keyword and the “class” keyword specifies one or more attributes for one or more management objects in the distributed system that are included in the view.

11. The method as set forth in claim 1 wherein the view definition language reserves a “readwrite” keyword and the “readwrite” keyword specifies whether individual set methods are to be generated during the processing step.

12. The method as set forth in claim 1, further including the step:
f) defining an options file with one or more commands for customizing operation of the processing step, wherein the processing is subsequently performed in accordance with the one or more commands in the options file.

13. The method as set forth in claim 12 wherein the options file includes at least one of an “include-module” command, an “exclude-module” command, a “collection-mo-list” command, a “default-mo-list” command, a “root-dm-gen-flag” command, a “root-dm-class-name” command, a “generate-make-file-flag” command, a “make-file-name” command, a “compact-mo-gen-flag” command, a “row-status-flag” command, an “enforce-enum-flag” command, a “generate-root-classes-flag” command, a “mo-impl-name” command, and a “mo-impl-gen-flag” command.

14. The method as set forth in claim 12, further including the step:
g) initiating the processing step with a command with one or more command line options for customizing operation of the processing step, wherein the processing is subsequently performed in accordance with the one or more command line options in the initiate processing step command.

15. The method as set forth in claim 14 wherein the initiate processing step command includes at least one of a first command line option that specifies a list of one or more views that will access data associated with the one or more managed objects directly, a second command line option that specifies a list of one or more views that will access data associated with the one or more managed objects remotely, a third command line option that specifies a view definition language file to be processed, a fourth command line option that specifies a managed object definition language file to be processed, a fifth command line option that specifies the options file to be used for customizing the processing step, and a sixth command line option that specifies a storage location for the programming language classes.

16. A method of defining a view of a network to facilitate development of an application program with view management services to manage the network, the method including the steps:
a) defining one or more managed objects associated with the network in an object-oriented managed object definition language and storing the definition of the one or more managed objects in one or more managed object definition language files, wherein the definition of the one or more managed objects is based on an existing design and hierarchical structure of the network, wherein parent-child relationships between the one or more managed objects are identified in the one or more managed object definition language files using the object-oriented managed object definition language to define the one or more managed objects in relation to the hierarchical structure of the network;
b) parsing the one or more managed object definition language files to ensure conformity with the object-oriented managed object definition language and creating an intermediate representation of the network from the one or more conforming managed object definition language files, wherein the intermediate representation of the network created in the parsing step includes object meta-data;
c) defining one or more views of the one or more managed objects of the network in a view definition language and storing the definition of the one or more views in one or more view definition language files, wherein the view definition language is based at least in part on the managed object definition language;
d) parsing the one or more view definition language files to ensure conformity with the view definition language and creating an intermediate representation of the one or more views of the network from the one or more conforming view definition language files, wherein the intermediate representation of the one or more views of the network includes view meta-data; and
e) processing the object meta-data and the view meta-data to form one or more programming language classes associated with the view management services, wherein the one or more programming language classes formed include at least one of a managed object view class, an abstract view class, a callback class, a view definitions class, and a view factories class.

17. The method as set forth in claim 16 wherein the abstract view class includes at least one of a cache view class and a database view class.

18. The method as set forth in claim 17 wherein the cache view class includes a CORBA view class.

19. The method as set forth in claim 16 wherein the one or more programming language classes are formed in a C++ programming language.

20. A method of defining a view of a network to facilitate development of an application program with view management services to manage the network, the method including the steps:
a) defining one or more managed objects associated with the network in an object-oriented managed object definition language and storing the definition of the one or more managed objects in one or more managed object definition language files, wherein the definition of the one or more managed objects is based on an existing design and hierarchical structure of the network, wherein parent-child relationships between the one or more managed objects are identified in the one or more managed object definition language files using the object-oriented managed object definition language to define the one or more managed objects in relation to the hierarchical structure of the network;
b) parsing the one or more managed object definition language files to ensure conformity with the object-oriented managed object definition language and creating an intermediate representation of the network from the one or more conforming managed object definition language files, wherein the intermediate representation of the network includes object meta-data;
c) defining one or more views of the one or more managed objects of the network in a view definition language and storing the definition of the one or more views in one or more view definition language files, wherein the view definition language is based at least in part on the managed object definition language;
d) parsing the one or more view definition language files to ensure conformity with the view definition language and creating an intermediate representation of the one or more views of the network from the one or more conforming view definition language files, wherein the intermediate representation of the one or more views of the network includes view meta-data; and
e) processing the object meta-data and the view meta-data to form one or more programming language classes associated with the view management services, wherein the one or more programming language classes include a managed object view class, an abstract view class, a callback class, a view definitions class, and a view factories class, wherein the abstract view class includes a cache view class and a database view class, wherein the cache view class includes a CORBA view class.

21. The method as set forth in claim 20, further including the step:
f) defining an options file with one or more commands for customizing operation of the processing step, wherein the processing is subsequently performed in accordance with the one or more commands in the options file.

22. The method as set forth in claim 20, further including the step:
f) initiating the processing step with a command having one or more command line options for customizing operation of the processing step, wherein the processing is subsequently performed in accordance with the one or more command line options in the initiate processing step command.
